(19) United States
(12) Patent Application Publication
(10) Pub. No.: US 2025/0067864 A1
(43) Pub. Date: Feb. 27, 2025

(54) CAMERA SENSOR ACTUATION

(71) Applicant: Ford Global Technologies, LLC, Dearborn, MI (US)

(72) Inventors: Sai Prasanth Velusamy, Westland, MI (US); Vivekanandh Elangovan, Canton, MI (US); Mahmoud Yousef Ghannam, Canton, MI (US)

(73) Assignee: Ford Global Technologies, LLC, Dearborn, MI (US)

(21) Appl. No.: 18/452,711

(22) Filed: Aug. 21, 2023

(51) Int. Cl. G01S 13/86; G01S 13/62; G01S 13/88; H04N 7/18; H04N 23/611

(52) U.S. Cl. CPC G01S 13/867; G01S 13/62; G01S 13/88; H04N 7/188; H04N 23/611

(57) ABSTRACT

An example system can include a computer having a processor coupled to a memory, the memory can store instructions executable by the processor to process a received Doppler radar signal to extract a feature that represents a characteristic of a moving object. Responsive to determining that the moving object excludes an authorized user based on the extracted feature, the computer can actuate a camera sensor.

### BACKGROUND

A system or environment such as a vehicle may be equipped with security features. For example, security features for a vehicle may determine whether a person attempting to enter and/or operate the vehicle is an authorized user. In some instances, security-related components, such as camera sensors and computerized image processing, can represent significant vehicle sensing and processing resources.

### BRIEF DESCRIPTION OF THE DRAWINGS

FIG. 1 shows an example vehicle system.

FIG. 2 shows example components involved in performing camera sensor actuation.

FIGS. 3-4 shows example Doppler signal features.

FIG. 5 is a diagram of an example process flow for camera sensor actuation.

### DETAILED DESCRIPTION

The present disclosure describes techniques for camera sensor actuation in a system, which may include a vehicle system. However, although example systems disclosed herein can include one or more camera sensors mounted on a vehicle, camera sensor actuation may be utilized to control access to other types of systems, such as systems for controlling access to buildings or facilities within buildings, or for controlling access to complex machinery other than vehicle systems. The camera sensors can have a field-of-view that permits the sensors to observe static or moving objects located in any direction with respect to the vehicle while the vehicle is proceeding along a path or while the vehicle is deactivated, parked (i.e., at rest), and unattended. Actuation of camera sensors in response to the vehicle being deactivated, parked, and unattended by a vehicle user (e.g., an operator or passenger) can operate to monitor the area external to the vehicle over extended periods of time. Such monitoring of the environment external to the vehicle may deter vehicle theft, vehicle break-in, damage, vandalism, etc., as well as providing a reporting channel from the vehicle to the vehicle's owner, an insurance company, a security services company, etc. Vehicle-mounted camera sensors can also be used in image recognition vehicle applications, in which an image of a person approaching the vehicle can be captured and processed utilizing image processing programming of a vehicle computer. Such image processing may permit the vehicle computer to determine whether the approaching person is an authorized user, e.g., an operator or authorized passenger, of the vehicle.

However, camera sensor monitoring of areas external to a deactivated vehicle can cause a significant drain on the battery resources of the vehicle. Thus, the duration of camera sensor operation may be reduced, so as to conserve battery resources so that such resources can be available to activate, e.g., actuate ignition of the vehicle, and/or to activate various battery-powered vehicle systems. In response to reducing the duration of camera sensor monitoring in an environment external to a deactivated vehicle, the vehicle may be more prone to theft, break-in, damage, vandalism, etc. In addition, the ability to obtain still or video images of persons involved in such events, e.g., for subsequent investigations, may be diminished. Further, other vehicle convenience features, e.g., illuminating cabin lighting when an authorized user (e.g., authorized operator or passenger) approaches the vehicle, unlocking of vehicle doors to permit keyless entry into the vehicle, etc., may be unavailable due to a loss of battery resources to execute these functions.

As described herein a vehicle radar may be utilized to monitor the vehicle's external environment. The radar may be utilized in place of or to supplement camera sensor monitoring of an environment external to a deactivated vehicle. Thus, a vehicle radar, which may be used during driving operations to detect static or moving objects in the vehicle's environment, may also be utilized to provide monitoring of the vehicle's external environment while the vehicle is parked, deactivated, and unattended. As described herein, the vehicle radar may be operated in a Doppler mode, which may operate to transmit Doppler signals and, based on Doppler signals received from a moving object, determine whether the moving object represents an authorized user, e.g., operator or passenger, of the vehicle. In an example, in response to the Doppler radar detecting that a person approaching the vehicle does not represent an authorized user, the vehicle computer may selectively actuate a camera sensor to record images of the approaching moving object and then deactivate the camera sensor after recording and/or transmitting images of the unauthorized person to a server via a wireless communications link. In another example, in response to the Doppler radar detecting that a person approaching the vehicle represents an authorized user, the vehicle computer may maintain the camera sensor in a deactivated state. As a result of such selective use of camera sensors and computerized image processing, battery resources may be conserved to as to be available so that the vehicle computer can actuate vehicle engine ignition as well as actuate convenience features, such as permitting keyless entry into the vehicle, illuminating cabin lighting, etc.

In an example, a system can include a computer having a processor coupled to a memory. The memory can store instructions executable by the processor to process a received Doppler radar signal to extract a feature that represents a characteristic of a moving object. The instructions may additionally, in response to determining that the moving object excludes an authorized user based on the extracted feature, actuate a camera sensor.

In an example, the characteristic can be at least one of a gait, a heel strike, an arm swing, a head nod, a twist, or a turn of the authorized user.

In an example, the Doppler radar signal can include a dominant signal reflected from the moving object, and wherein the extracted feature indicates a characteristic gait based on the dominant signal.

In an example, the instructions can further include instructions to compute a composite feature of the authorized user based on a relationship between two or more extracted features of the Doppler radar signal.

In an example, the instructions can further include instructions to determine a trajectory of the moving object based on a dominant feature of the Doppler radar signal.

In an example, the instructions can further include instructions to determine a trajectory of the moving object and to assign a threat index to the moving object based on the trajectory.

In an example, the instructions can further include instructions to increase the threat index based on the trajectory indicating movement of the moving object toward the system.

An example, the camera sensor can include a vehicle-mounted camera sensor having a field-of-view that includes the location of the moving object.

In an example, the camera sensor can include a vehicle-mounted camera sensor having a field-of-view that includes the moving object, in which actuation of the camera sensor includes capturing video images of the moving object.

In an example, the instructions can further include instructions to maintain the camera sensor in a deactivated state responsive to the moving object being determined to include the authorized user.

In an example, the instructions further include instructions to transition the system from a Doppler radar operational mode to a Bluetooth operational mode after executing the instructions to actuate the camera sensor.

In an example, the instructions can further include instructions to refine a computer model that includes the characteristic of the moving object based on successful recognitions that the moving object includes the authorized user.

In another example, a method can include processing a received Doppler radar signal to extract a feature that represents a characteristic of a moving object. The method can additionally include determining that the moving object excludes an authorized user based on the extracted feature and actuating a camera sensor.

In an example, the characteristic can be at least one of a gait, a heel strike, an arm swing, a head nod, a twist, or a turn of the authorized user.

In an example, the method can additionally include determining a trajectory of the moving object based on a dominant feature of the Doppler radar signal reflected from the moving object.

In an example, the method can additionally include determining a trajectory of the moving object and assigning a threat index to the moving object based on the trajectory.

In an example, the method can additionally include assigning an increased threat index based on the trajectory indicating movement of the moving object toward the camera sensor.

In an example, the method can additionally include maintaining the camera sensor in a deactivated state responsive to determining that the moving object includes the authorized user.

In an example, the method can additionally include transitioning the Doppler radar to a Bluetooth operational mode after actuating the camera sensor.

In an example, the method can additionally include refining a computer model that includes the characteristic of the authorized user based on successful recognitions that the moving object includes the authorized user.

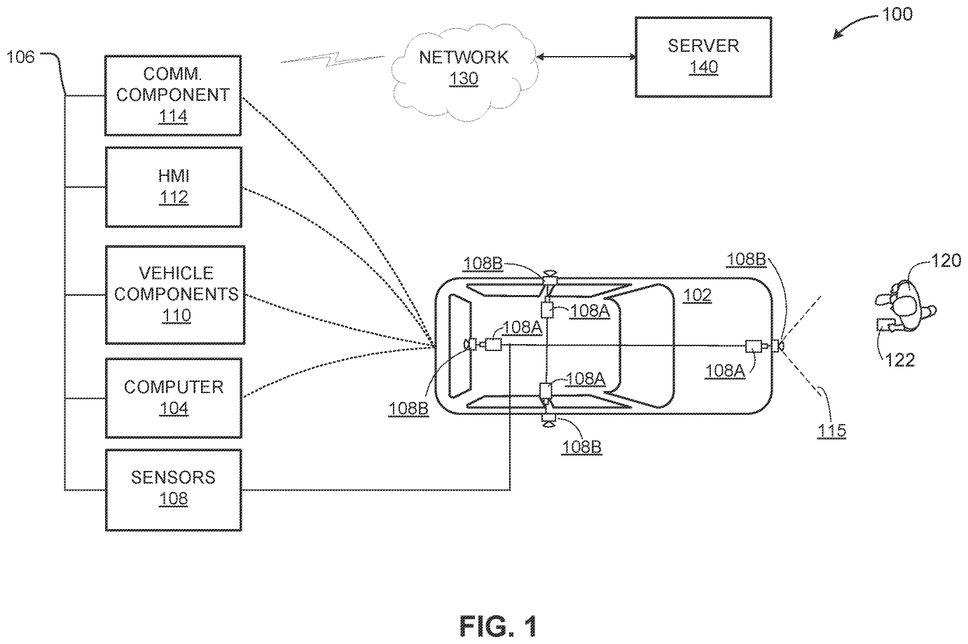

FIG. 1 illustrates an example system 100 for operating sensors 108 of vehicle 102. Computer 104 of vehicle 102 can be programmed to receive and process signals representing data output from various sensors 108, including camera sensor 108A. In an example, output data from camera sensors 108A may include data representing fixed or moving objects relative to vehicle 102 while the vehicle is in motion or while the vehicle is parked, deactivated, and unattended. Output data from camera sensors 108A can be transmitted to computer 104 utilizing, for example, vehicle network 106. In response to receipt of digitized images, programming of computer 104 may execute any suitable image processing programming that operates to extract features of received still or video images. Thus, in an example, in response to person 120 approaching vehicle 102, one or more of camera sensors 108A may capture an image of the facial features of person 120. The digitized image may be processed to extract the facial features of person 120. The extracted facial features of person 120 may then be compared with extracted facial features of authorized users, e.g., operators or passengers, of vehicle 102. In response to a threshold level of correlation, e.g., 0.85, 0.9, 0.95, between the extracted facial features of person 120 and the facial features of the authorized users, e.g., operators or passengers, of vehicle 102 stored in a memory accessible by computer 104, the vehicle may illuminate cabin lighting of the vehicle, start the vehicle's engine, actuate the vehicle's horn, deactivate (e.g., unlock) the rear or front vehicle trunk, actuate the vehicle liftgate, initiate the vehicle's climate control system, actuate a pattern of external vehicle lighting, illuminate areas near the vehicle's entry or on handles of doors, liftgate, front and/or rear trunk, etc. In some instances, in response to a lower correlation, certain vehicle features may be actuated, such as illuminating areas near vehicle entry points. In response to a higher correlation, other vehicle features may be actuated, such as actuation of door locks, vehicle ignition, etc. In an example, a correlation greater than a threshold level (e.g., 0.85, 0.9, 0.95) indicates a higher level of confidence that the extracted facial features of person 120 correspond to those of an authorized operator or passenger of vehicle 102.

Sensors 108 of vehicle 102 additionally include radio frequency (RF) sensors 108B. In the example of FIG. 1, RF sensors 108B can include radar sensors, such as Doppler radar sensors, which operate to provide recognition of person 120 based on a Doppler signal feature that is representative of the person. In this context, a “Doppler signal feature” for a person means the features of a reflected Doppler signal that can identify the person based on the person's movements in an environment such as the environment external to vehicle 102. Doppler signal features include a “dominant Doppler signal feature,” which means a reflected Doppler signal having an amplitude that is proportional to the physical size of person 120 and having a frequency that is shifted, with respect to a transmitted Doppler radar signal, i.e., that typically increases in proportion to the person's gait speed, e.g., 5.0 km/hour 6.0 km/hour, 7.0 km/hour, etc. Thus, a dominant Doppler signal feature provides a measure of the size and gait speed of person 120. A Doppler signal feature that represents a person additionally includes a Doppler side frequency feature, which means a frequency, outside of the frequency of the dominant Doppler signal feature, which provides a measure of the speed of a limb (e.g., speed of characteristic arm swing or characteristic leg motion) of person 120 and the amplitude of the return signal from the limb of person 120. In this context, the term “characteristic” means a distinguishable manner of movement of an object, such as person 120. Thus, as a person, e.g., person 120 walks toward or away from vehicle 102, the person exhibits characteristic movements. Thus, in an example, as person 120 approaches vehicle 102, the limbs of person 120 may intermittently and characteristically move at a greater speed than the gait speed of person 120. In another example the characteristic intermittent movements of the legs of person 120 may begin as the person moves a first leg forward and ends as the heel of the first leg strikes or contacts the ground. In another example, characteristic movements of the arms and hands of person 120 may intermittently move at a greater speed than the gait speed of the person as the person's arms swing while walking. In other examples, as person 120 walks approaches or retreats from vehicle 102, or walks in a direction lateral to vehicle 102 (e.g., from a direction to the left of vehicle 102 to the right of vehicle 102) other intermittent movements, such as turns, head nods, twists, hip swings, etc., may give rise to Doppler signal features that can characterize person 120.

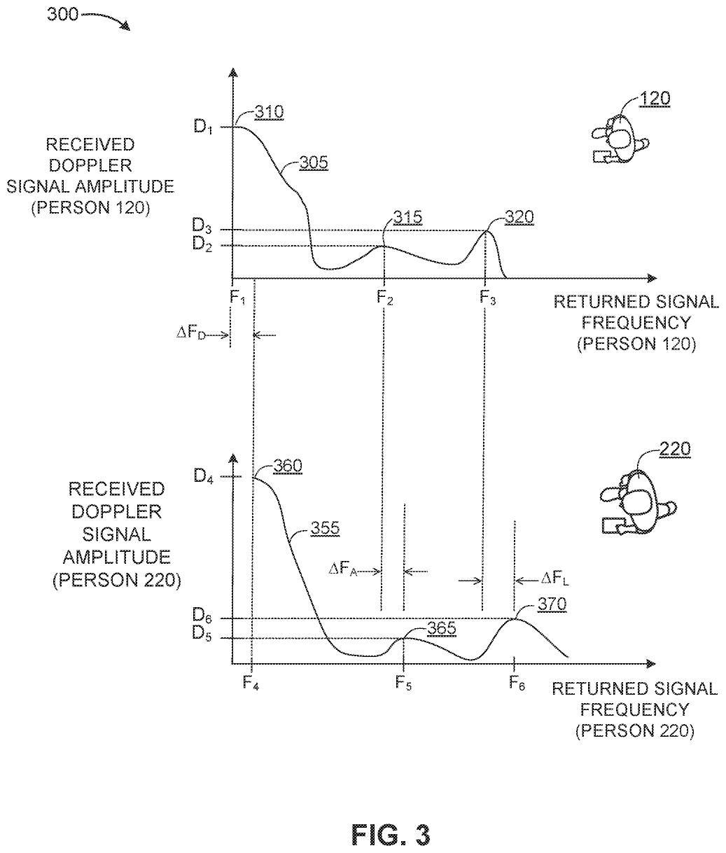

In addition, and as described in greater detail below in reference to FIG. 3, in response to person 120 being average in stature, the gait speed of a first person 120 may be less than the gait speed of a person who is relatively tall, e.g., second person 220. Accordingly, the dominant Doppler signal feature that represents the gait of person 120 may include a frequency shift that is less than the Doppler signal feature of a person who is relatively tall, e.g., person 220. Further, also in response to person 120 being average in stature, a Doppler side frequency feature, which provides a measure of the characteristic arm and leg motion of person 120, may be smaller than a Doppler side frequency feature of a person who is relatively tall in stature. Additionally, in response to person 120 having relatively larger-sized arms and/or legs, a Doppler side frequency feature may be larger in amplitude than a Doppler side frequency feature of a similar sized person having smaller arms and/or legs than those of person 120.

Similar to extraction of facial features to determine whether person 120 represents an authorized user, e.g., an authorized operator or passenger, of vehicle 102, a Doppler signal feature can be utilized to determine whether person 120 represents an authorized user, e.g., an authorized operator or passenger, of vehicle 102. In an example, in response to a first threshold level of correlation, e.g., 0.85, 0.9, 0.95, between a Doppler signal feature that represents person 120 and the Doppler signal feature that represents an authorized user, e.g., operator or passenger, of vehicle 102 stored in a memory accessible to computer 104, the vehicle may illuminate cabin lighting of the vehicle, start the vehicle's engine, actuate the vehicle's horn, etc. In response to determining the first level of correlation between the Doppler signal features of person 120 and the Doppler signal features of an authorized user, camera sensor 108A can remain deactivated, thus conserving battery resources of vehicle 102.

In another example, in response to a second threshold level of correlation, e.g., 0.7, 0.75, 0.8, between the Doppler signal features of person 120 and the Doppler signal features of authorized users of vehicle 102, programming of computer 104 may actuate one or more of camera sensors 108A. Actuation of one or more of camera sensors 108A may result in the camera sensors capturing still or video images of person 120 for transmission via communications component 114 through network 130 to server 140. Server 140 can store features extracted from still or video images of person 120, 220, for use by the owner of vehicle 102, an insurance company, a security organization, etc.

RF sensors 108B can include at least two modes of operation. In a first mode of operation, sensors 108B can perform Doppler radar functions, including transmitting a Doppler radar signal to an area external to vehicle 102 and processing a received a Doppler radar signal reflected from a moving object within field-of-view 115. With respect to a moving object, RF sensors 108B can determine Doppler signal features, which include a dominant Doppler signal feature and one or more Doppler side frequency features as discussed above. In addition, RF sensors 108B can transition from a Doppler mode to a Bluetooth localization mode in response to control signals from computer 104. In response to such transitioning, RF sensors 108B can localize an authorized user, e.g., operator or passenger, based on credentials stored within the authorized user's mobile communications device 122. In the example of FIG. 1, Doppler radar operations utilize a frequency that is substantially similar to frequencies utilized for Bluetooth operational modes, such as frequencies of between 5.0 gigahertz and 20.0 gigahertz. Thus, in an example, RF sensors 108B can operate to perform Doppler radar signal transmission, reception, and Doppler signal feature extraction, and then transition to a Bluetooth localization mode that allows mobile communications device 122 to operate in a phone-as-a-key mode. In the phone-as-a-key mode, computer 104 may actuate door unlocking mechanisms to permit keyless entry to vehicle 102, to start the engine of vehicle 102, and/or to actuate lighting, e.g., interior lights, headlights, running lights, etc. Thus, person 120 may be permitted to operate vehicle 102 without the use of a physical key, a key fob, or other dedicated device.

Sensors 108 of vehicle 102 can include sensors other than camera sensors 108A and RF sensors 108B, such as sensors for monitoring and detecting aspects of the vehicle's driving environment. Such sensors can include long-range radar sensors, LIDAR sensors, ultrasonic transducers, motion detectors, etc. Further, vehicle 102 can include sensors for measuring internal vehicle states and modes, such as a sensor to measure engine speed (in revolutions per minute) such as a tachometer, wheel speed sensors, tire pressure sensors, etc.

Computer 104 can be generally programmed for communications on vehicle network 106, which may include a communications bus such as a CAN bus, LIN bus, etc., and/or other wired and/or wireless technologies, e.g., Ethernet, WIFI, Bluetooth®, Ultra-Wideband (UWB), etc. Vehicle network 106 can represent one or more mechanisms by which computer 104 may communicate with a remote computer, such as a remote server. Accordingly, vehicle network 106 can include one or more of various wired or wireless communication mechanisms, including any desired combination of wired (e.g., cable and fiber) and/or wireless, e.g., cellular, wireless, satellite, microwave, and radio frequency) communication mechanisms and any desired network topology (or topologies when multiple communication mechanisms are utilized). Exemplary communication networks include wireless communication networks, e.g., using Bluetooth®, Bluetooth® Low Energy (BLE), UWB, IEEE 802.11, vehicle-to-vehicle (V2V) such as Dedicated Short-Range Communications (DSRC), etc.), local area networks (LAN) and/or wide area networks (WAN), including the Internet, providing data communication services.

Alternatively or additionally, in examples in which computer 104 includes multiple devices, vehicle network 106 can be used for communications between devices represented as computer 104. In an example, computer 104 can be a generic computer with a processor and memory as described above and/or may include an electronic control unit (ECU) or controller or the like for a specific function or set of functions, and/or a dedicated electronic circuit including an ASIC that is manufactured for a particular operation, e.g., an ASIC for processing sensor data and/or communicating the sensor data. In another example, computer 104 may include an FPGA (Field-Programmable Gate Array) which is an integrated circuit manufactured to be configurable by an authorized user. Typically, a hardware description language such as VHDL (Very-High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in computer 104. In addition, computer 104 may be programmed for communicating with communications component 114, human-machine interface (HMI) 112, and vehicle components utilizing vehicle network 106, which, as described below, may include various wired and/or wireless networking technologies, e.g., cellular, Bluetooth®, Bluetooth® Low Energy (BLE), UWB, wired and/or wireless packet networks, etc.

Vehicle 102 can include a variety of additional devices, such as vehicle components 110, which may utilize vehicle network 106 to transmit and receive, for example, data relating to vehicle speed, acceleration, location, subsystem and/or component status, etc. In an example, additional sensors of vehicle 102 can provide data for controlling operation of a component of a set of vehicle components 110, such as a component for controlling an aspect of vehicle operation. Vehicle components 110 can include other hardware entities adapted to perform a mechanical or electromechanical function or operation, such as moving vehicle 102, slowing or stopping the vehicle, steering the vehicle, etc. Vehicle components 110 can include transmission components, steering components, (which may include one or more of a steering wheel, a steering rack, etc.), a brake component, a park assist component, an adaptive cruise control component, an adaptive steering component, a movable seat, and the like. Vehicle components 110 can further include computing devices, e.g., electronic control units (ECUs) or the like and/or computing devices such as described above with respect to computer 104, and that likewise communicate via vehicle network 106.

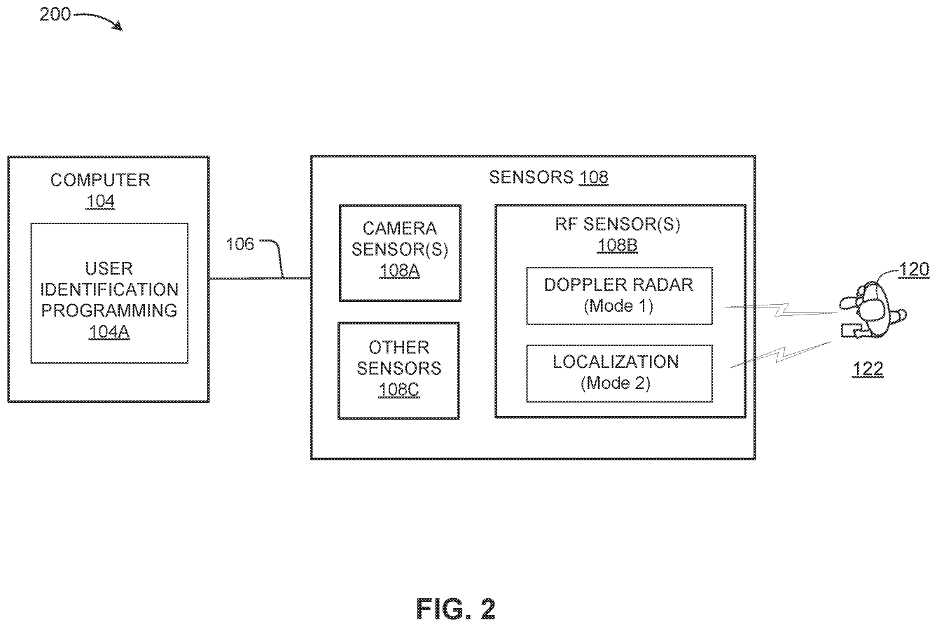

FIG. 2 shows example subsystem 200 involved in performing camera sensor actuation. As seen in FIG. 2, computer 104 includes user identification programming 104A, which may be stored in a memory accessible to computer 104. User identification programming 104A may include a table or other suitable data structure that stores facial features of authorized operators or passengers of vehicle 102. Thus, in response to receiving an image from camera sensors 108A of, for example, person 120 of FIG. 1, user identification programming 104A may extract features from the received image and determine whether the extracted features correlate with stored features extracted from digital images of authorized users of vehicle 102. In an example, in response to determining a threshold correlation, e.g., 0.85, 0.9, 0.95, etc., between extracted features of the received image and stored extracted features of authorized users, e.g., operators or passengers, of vehicle 102, programming of computer 104 can actuate keyless entry of vehicle 102, illuminate cabin lights of vehicle 102, etc. In response to determining a lower correlation, e.g., less than 0.85, user identification programming 104A can deactivate keyless entry of vehicle 102 and maintain cabin lights in a deactivated state.

User identification programming 104A can additionally include a table or the like storing Doppler signal features, e.g., dominant Doppler signal features and Doppler side frequency features, of authorized operators and passengers of vehicle 102. Thus, in response to receiving a Doppler signal feature from RF sensor 108B that represents person 120, user identification programming 104A can determine whether the received Doppler signal features correlate with stored Doppler signal features of authorized users, e.g., operators or passengers, of vehicle 102. In an example, in response to determining a threshold correlation, e.g., 0.85, 0.9, 0.95, etc., between received Doppler signal features and stored Doppler signal features representative of authorized users of vehicle 102, programming 104A can actuate keyless entry of vehicle 102, illuminate cabin lights of vehicle 102, etc. In addition, user identification programming 104A can maintain camera sensor 108A in a deactivated state. In another example, in response to determining a lower correlation, e.g., less than 0.85, user identification programming 104A can deactivate keyless entry of vehicle 102 and maintain cabin lights in a deactivated state. Further, user identification programming 104A can actuate camera sensor 108A to capture still or video images of person 120 for transmission to server 140.

As described in reference to FIG. 1, RF sensors 108B of FIG. 2 can operate in a Doppler radar mode, which permits transmission and reception of Doppler radar signals to and from moving objects and can also operate in a Bluetooth localization mode. During Doppler radar mode operations, RF sensor 108B can transmit a signal to a moving object located external to vehicle 102 and receive signals reflected from the moving object. RF sensor 108B can then process the reflected Doppler signal to extract the Doppler signal features, e.g., a dominant Doppler signal feature and a Doppler side frequency feature. The Doppler signal features extracted by RF sensor 108B can then be transmitted to computer 104, utilizing vehicle network 106, for comparison with Doppler signal features that represent those of authorized users, e.g., operators or passengers, of vehicle 102. RF sensors 108B can then transition to a Bluetooth phone-as-a-key mode, in which RF sensor 108B receives a beacon signal from mobile communications device 122 to permit person 120 to operate vehicle 102 without use of a physical key, a key fob, or other dedicated device. In an example, RF sensors 108B transition between the Doppler radar mode and the Bluetooth phone-as-a-key mode at intervals of between 100 milliseconds and 2.0 seconds.

Such transitions between operating modes of RF sensor 108B can permit sensors 108B to perform a dual or twofold function under the control of user identification programming 104A. For example, during a first interval, user identification programming 104A can instruct RF sensor 108B to operate in a Doppler radar mode, in which Doppler radar signals are transmitted to and received from a moving object external to vehicle 102. RF sensor 108B can then receive a signal reflected from the moving object and extract Doppler signal features, such as dominant Doppler signal features 310 and Doppler side frequency feature 315, from received Doppler radar signal. RF sensor 108B can then transition to a Bluetooth phone-as-a-key mode, to detect a beacon transmitted from mobile communications device 122.

FIG. 3 shows graphs representing example Doppler signal features 300, which may be included in a return signal from a moving object, such as person 120. In FIG. 3, the vertical axis in each graph represents Doppler signal amplitude and the horizontal axis represents the frequency of a received Doppler signal. Signal profile 305 shows the amplitude and frequency of a dominant signal as well as first and second frequencies outside of (or to the side of) the dominant Doppler signal that results from a Doppler radar signal reflected from person 120 approaching vehicle 102. Signal profile 355 includes the dominant Doppler signal feature (310) and side frequency (315) resulting from a Doppler radar signal reflected from person 220, also approaching vehicle 102. With respect to both persons 120 and 220, and as described in reference to FIG. 1, a reflected Doppler radar signal may be shifted in frequency with respect to a transmitted Doppler radar signal. Such frequency shifts increase in proportion to the gait speed of an approaching person, e.g., 120, 220. Thus, in response to persons 120 and 220 walking toward vehicle 102 at their respective gait speeds, received Doppler radar signals include an increased frequency with respect to the transmitted Doppler radar signal. Also, in response to persons 120 and 220 walking away from vehicle 102, received Doppler radar signals include a decreased frequency with respect to the transmitted Doppler radar signal. Further, as persons 120 and 220 approach vehicle 102, the limbs, e.g., arms, legs, hands, feet, of persons 120 and 220 may intermittently move at a greater speed than the person's gait speed. Such movements of the legs of persons 120 and 220 may begin as each person moves a first leg forward and end as the heel of the first leg contacts or strikes the ground (e.g., heel strike). Further, characteristic movements of the arms and hands of persons 120 and 220 may intermittently move at a greater speed than the gait speed of the person as the person's arms swing while walking. In another example, another portion of the body of person 120 may intermittently move as the person walks, such as the head of person 120 (e.g., a head nod), the hips of person 120 (e.g., a hip twist or turn), etc.

Thus, as seen in FIG. 3, a first example received Doppler radar signal having profile 305 includes dominant Doppler signal feature 310 having an amplitude D₁ and a frequency F₁. In an example, the amplitude (D₁) of dominant Doppler signal feature 310 is indicative of the physical size of person 120, which may establish an amount of Doppler radar signal reflected by the body of person 120. For example, in response to person 120 being of average stature, e.g., with respect to a larger or taller person, e.g., person 220, person 120 may reflect a first amplitude of the Doppler signal transmitted by RF sensor 108B. Further, according to the gait (walking) speed of person 120, e.g., 5.0 km/hour 6.0 km/hour, 7.0 km/hour, etc., the frequency (F₁) of dominant Doppler signal feature 310 may shift with respect to the transmitted Doppler radar signal transmitted by RF sensor 108B.

Signal profile 305 additionally shows first Doppler side frequency feature 315, having frequency F₂ and having an amplitude of D₂. In the example of FIG. 3, Doppler side frequency feature F₂ can correspond to the characteristic arm swing of person 120 as the person approaches vehicle 102. Doppler side frequency feature F₃ can correspond to the characteristic leg motion of person 120, as the person's legs advance toward vehicle 102. As seen in FIG. 3, first Doppler side frequency feature 315, e.g., characteristic arm swing, includes an amplitude feature that is decreased in relation to second Doppler side frequency feature 320 (F₃), e.g., characteristic leg motion, which indicates that the legs of person 120 reflect a larger portion of the transmitted Doppler radar signal than the arms of person 120. Second Doppler side frequency feature 320 is increased relative to first Doppler side frequency feature 315 (e.g., characteristic arm swing), which indicates that the legs of person 120 move intermittently with a greater speed than the arm swing of person 120.

FIG. 3 additionally depicts a graph of a second example signal profile 355, which includes dominant Doppler signal feature 360, having an amplitude D₄ and a frequency F₄. In an example, dominant Doppler signal feature 360 is indicative of the physical stature of person 220, which may establish the amount of Doppler radar signal that the body of person 220 reflects. For example, in response to person 220 being of relatively tall or large stature, e.g., with respect to person 120, dominant Doppler signal feature 360 may be greater than dominant Doppler signal feature 310. Further, according to the gait (walking) speed of person 220, e.g., 6.0 km/hour, 7.0 km/hour, 8.0 km/hour, etc., the frequency (F₄) of dominant Doppler signal feature 360 may shift with respect to dominant Doppler signal feature 310 (of person 120).

Signal profile 355 additionally shows Doppler side frequency feature 365, having a frequency of F₅ and having an amplitude of D₅. Signal profile 355 further shows Doppler side frequency feature 370, having a frequency of F₆ and an amplitude of D₆. In the example of FIG. 3, Doppler side frequency feature 365 can correspond to the characteristic arm swing of person 220 as the person approaches vehicle 102. Doppler side frequency F₆ can correspond to the characteristic leg motion of person 220, as the person's legs advance toward vehicle 102. As seen in FIG. 3, Doppler side frequency feature F₅, e.g., characteristic arm swing, includes an amplitude that is decreased in relation to Doppler side frequency F₆, e.g., characteristic leg motion, which indicates that the legs of person 120 reflect a larger portion of the Doppler signal transmitted by RF sensor 108B than the arms of person 220.

Thus, it can be seen from FIG. 3 that for a Doppler radar signal transmitted by RF sensor 108B, signal profiles, e.g., 305, 355, which include dominant Doppler signal features, e.g., 310, 360, and Doppler side frequency features, e.g., 315, 320, 365, 370, differ in accordance with the physical characteristics (i.e., characteristic arm swing and characteristic leg motion) of persons 120 and 220. In the example of person 120 being of medium stature, the dominant Doppler signal feature 310 includes a frequency F₁ and an amplitude D₁. Further, Doppler side frequency features 315 and 320, which result from the characteristic arm swing and the leg motions of person 120, exhibit amplitude features D₂ and D₃, respectively. In addition, as person 120 moves toward vehicle 102, the ratios (or other type of numerical relationship) between D₁ and D₂ and between D₁ and D₃ remain constant since the cross-sectional areas presented by the feature of person 120, e.g., head, chest, arms, hands, legs, feet, etc., remain constant.

Accordingly, two or more features, e.g., dominant Doppler signal feature 310, Doppler side frequency feature 315, Doppler side frequency 320, may be combined to represent a composite feature of person 120 computed or derived from the two or more features. Similarly, in the example of person 220, being of larger stature than person 120, dominant Doppler signal feature 360 includes a frequency F₄, and an amplitude of D₄. Further, Doppler side frequency features 365 and 370, which result from characteristic arm swing and leg motions, exhibit amplitudes D₅ and D₆, respectively. In an example, a composite amplitude feature of person 120 may be computed in response to dominant Doppler signal feature 310 having an amplitude (D₁) of −60 decibels relative to one milliwatt (dBm) to Doppler side frequency feature 315 having an amplitude (D₂) of −75 dBm. In this example, a composite amplitude feature of person 120 may be the ratio D₁/D₂, which would equal 0.8 (dimensionless). In another example, a composite frequency feature of person 120 may be computed in response to dominant Doppler signal feature 310 having a frequency (F₁) of 6.01 gigahertz to Doppler side frequency feature 315 having a frequency (F₂) of 6.02 gigahertz. In such an example, a composite frequency feature of person 120 may be the ratio F₁/F₂, which would equal 0.998 (dimensionless).

Thus, similar to that of person 120, as person 220 moves toward vehicle 102, the ratios (or other type of numerical relationships) D₄ and D₅ and between D₄ and D₆ remain constant since the cross-sectional areas presented by the portions of person 220, e.g., head, chest, arms, hands, legs, feet, etc., remain constant. Accordingly, two or more features, e.g., dominant Doppler signal feature 360, Doppler side frequency feature 365, Doppler side frequency 370, may form a composite feature of person 220 computed or derived from the two or more features Accordingly, as persons 120 and 220 move from a point relatively distant from vehicle 102 to a point relatively close to the vehicle, the overall shape of signal profiles 305 and 355 remain unchanged although each signal profile (305, 355) may be scaled along the received Doppler signal amplitude (vertical) axis.

Also as seen in FIG. 3, the frequency of dominant Doppler signal feature 360 of person 220 (F₄) is shifted in frequency with respect to dominant Doppler signal feature 310 of person 120 (F₁). The difference in frequency between dominant Doppler signal features 310 and 320 is indicated by ΔF_{D}. Additionally, Doppler side frequency feature 365 of person 220 (F₅), due to the characteristic arm swing of person 220, is shifted in frequency with respect to first Doppler side frequency feature 315 of person 120 (F₂) as indicated by ΔF_{A}. Further, Doppler side frequency feature 370 of person 220 (F₆), due to the characteristic leg motion of person 220, is shifted in frequency with respect to second Doppler side frequency feature 320 of person 120 (F₃) is indicated by ΔF_{L}. Thus, in accordance with the example of FIG. 3, user identification programming 104A can utilize such differences to identify and to distinguish between persons 120 and 220.

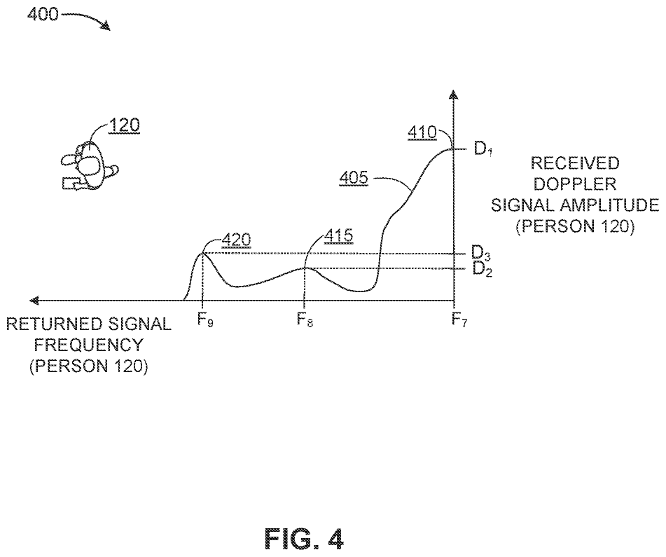

FIG. 4 shows example Doppler signal features 400, which may be included in a return signal from a moving object, such as person 120. Signal profile 405 indicates the Doppler signal features that results from processing a received Doppler radar signal reflected from person 120 retreating or walking away from vehicle 102. As seen in FIG. 4, in response to person 120 walking away from vehicle 102, Doppler side frequency features 415 and 420 are reduced in relation to dominant Doppler signal feature 410. For example, Doppler side frequency feature 415, due to the characteristic arm swing of person 120, is indicated as having a lower frequency than dominant Doppler signal feature 410. In addition, Doppler side frequency feature 415, due to the characteristic leg motion of person 120, is also indicated as having an even lower frequency with respect to dominant Doppler signal feature 410 due to the intermittent movement of the legs of person 120, as the person walks away from vehicle 102.

Thus, as seen in FIG. 4, signal profile 405 includes an overall shape that is similar, but reversed, with respect to signal profile 305. Such similarity in the overall shape of signal profile 405 and 305 results from the unchanging characteristic gait of person 120, whether person 120 approaches or retreats from vehicle 102. Accordingly, dominant Doppler signal feature 410 and Doppler side frequency features 415 and 420 can be utilized to identify person 120, whether the person approaches or retreats from vehicle 102.

As previously described, dominant Doppler signal features, e.g., 310, 360, and 410, can be utilized to determine the gait or walking speed of a person, e.g., 120, 220. Thus, in response to detection of a moving object, e.g., a person, moving at a speed that is greater than a walking speed, e.g., 6.0 km/hour, 7.0 km/hour, 8.0 km/hour, the dominant Doppler signal feature may indicate that a person, e.g., 120, 220, is running toward vehicle 102. Thus, based on the speed as indicated by a dominant Doppler signal feature (310, 360), e.g., person 120, 220, running toward vehicle 102, user identification programming 104A can assign a threat index, e.g., indicating possible imminent damage to vehicle 102. In an example, a person running toward vehicle 102, which may be indicated by a dominant Doppler signal feature (310, 360) examining a frequency shift proportional to the speed of the approaching person, along with Doppler side frequencies (315, 320, 365, 370) indicating high-speed arm swings and leg motions. In such an example, programming 104A can actuate camera sensor 108A to begin capturing still or video images of the approaching person, e.g., 120, 220, for transmission via communications component 114 through network 130 to server 140. Server 140 can store features extracted from still or video images of person 120, 220, for use by the owner of vehicle 102, an insurance company, a security organization, etc.

In another example, in response to numerous dominant Doppler signal features indicating that a group of persons, e.g., a chaotic mob of persons, appear to be approaching vehicle 102, programming 104A can assign a threat index, e.g., indicating possible imminent damage to the vehicle 102. In such an instance, a chaotic mob of persons may be determined by RF sensor 108B detecting a group of dominant Doppler signal features and a group of Doppler side frequencies In response, programming 104A can actuate camera sensor 108A so that still or video images of the group of approaching, and potentially chaotic, persons can be transmitted to server 140. In an example, a threat index may be based on a variety of factors, such as the speed of an approaching person, e.g., as determined by a frequency shift of a dominant Doppler signal feature, (e.g., 310, 360), a distance between the approaching person and vehicle 102, as determined by an amplitude of a dominant Doppler signal feature, (e.g., 310, 360), and/or a number of Doppler side frequency features, (e.g. 315, 320, 365, 370). A threat index can include a value of between 0.0 and 1.0 depending on various factors, such as the speed at which the person (120, 220) approaches vehicle 102, the number of persons approaching the vehicle, etc. In an example, a solitary person (120) approaching vehicle 102 that has not been identified as an authorized user, e.g., operator or passenger of vehicle 102, may be assigned a threat index of 0.4. In another example, a group of persons who appear to be moving rapidly toward vehicle 102 may be assigned an increased threat index, such as 0.9. In an example, as described in reference to FIG. 4, in response to an approaching person, e.g., 120, 220, moving away from vehicle 102, programming of computer 104 may remove the threat index, deactivate camera sensor 108A, and stop transmitting still and video images to server 140.

In an example, user identification programming 104A can utilize machine learning programming to refine a computer model that correlates dominant Doppler signal features, e.g., 310, 360, 410, and Doppler side frequency features, e.g., 315, 320, 365, 370, 415, 420, with known or enrolled users of vehicle 102. Alternatively or in addition, machine learning program could be trained to correlate dominant Doppler signal features and Doppler side frequencies to distinguish between a person, or group of persons, running toward a vehicle versus a person, or group of persons, casually strolling toward a vehicle. In an example, a user, e.g., an operator or passenger, of vehicle 102 may undergo an enrollment process, which allows an operator or a passenger to be recognized by user identification programming 104A. In an enrollment process, RF sensor 108B of vehicle 102 can capture reflected radar signals from a prospective user, e.g., an operator or passenger of the vehicle. RF sensor 108B may then extract dominant Doppler signal features (310, 360, 410) and Doppler side frequency features (315, 320, 365, 370, 415, 420) as the prospective user, e.g., operator or passenger, approaches vehicle 102. The dominant Doppler signal and side frequency features can then be utilized as a training set of input data to the computer model that implementing machine learning programming. The machine learning programming of user identification programming 104A can further training and/or refine the computer model over instances of successful recognition (e.g., true positives), incorrect recognition, (e.g., false positives), and related recognition events with respect to an authorized user, e.g., 120, 220. Accordingly, over time, the machine learning programming can enhance the computer model of the user so as to increase the capability of programming of computer 104 to recognize an authorized user, e.g., 120, 220.

It an example, a suitable machine learning program to implement the computer model may include a deep neural network (DNN) may be trained and then used to output, filter and/or predict whether an approaching person, e.g., 120, 220, includes an authorized user, e.g., operator or passenger, of vehicle 102. A DNN can include programming, which can be loaded in memory and executed by a processor included in computer 104 of vehicle 102, and/or a processor of the RF sensor 108B. In an example implementation, the DNN can include, but is not limited to, a convolutional neural network CNN, R-CNN Region-based CNN, Fast R-CNN, and Faster R-CNN. The DNN includes multiple nodes or neurons. The neurons are arranged so that the DNN includes an input layer, one or more hidden layers, and an output layer. The input and output layers may also include more than one node.

As an example, the DNN can be utilized to train the computer model with ground truth data, i.e., data about a real-world condition or state. For example, the DNN be utilized to train the computer model with ground truth data and/or updated with additional data. Weights can be initialized by using a Gaussian distribution, for example, and a bias for each node can be set to zero. Training of the computer model via the DNN can include updating weights and biases via suitable techniques such as back-propagation with optimizations. Ground truth data means data deemed to represent a real-world environment, e.g., conditions and/or objects in the environment. Thus, ground truth data can include sensor data depicting an environment, e.g., a time of day, location, weather conditions, etc., along with a label or labels describing the environment, e.g., a label describing the data, e.g., calendar event, receipt of a prior access message, etc.

In an example, user identification programming 104A can additionally utilize a time series of recognitions of a person, e.g., 120, 220, to determine whether the person is advancing toward (as described in reference to FIG. 3) or retreating from (as described in reference to FIG. 4) vehicle 102. Thus, over time, user identification programming 104A can determine a trajectory or other type of path over a time series of Doppler signal profiles (305, 355, 405). In an example, in response to person 120 moving in a zigzag manner, in which the person moves briefly toward vehicle 102 followed by movement away from vehicle 102, user identification programming 104A can detect such movements by evaluating changes in amplitude of dominant Doppler signal features, e.g., 310, 360, 410. A time series may extend over any suitable duration, such as five seconds, 10 seconds, 15 seconds, etc.

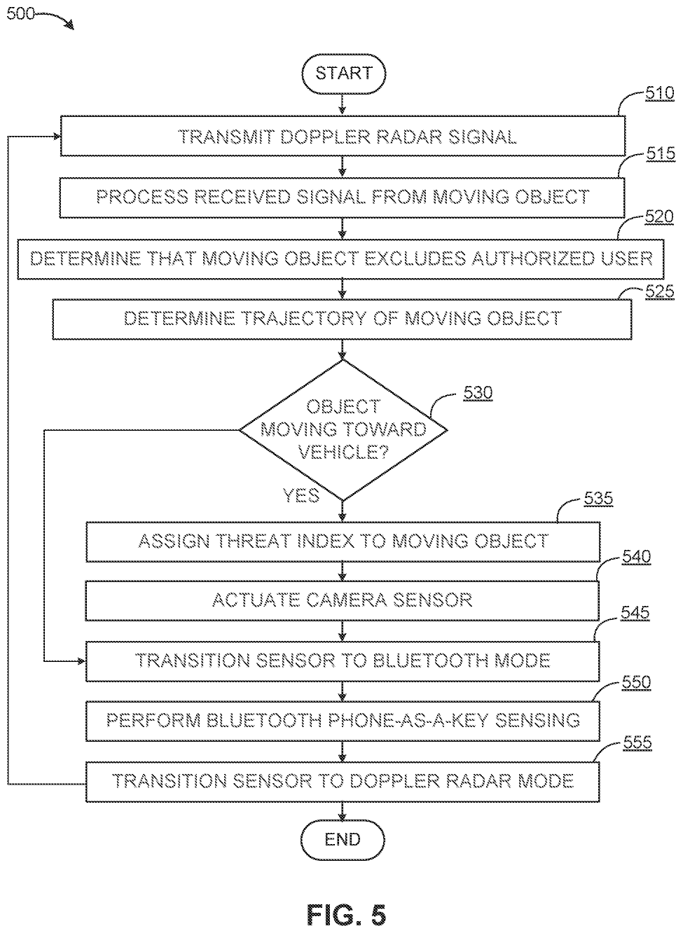

FIG. 5 is a diagram of an example process flow for camera sensor actuation. In an example implementation, programming of computer 104 utilizes camera sensors 108A to view areas external to vehicle 102 after deactivation of the vehicle. In the process of determining whether camera sensors 108A are to be actuated, vehicle 102 may utilize RF sensors 108B to transmit Doppler radar signals to the environment external to vehicle 102. In response to receiving a signal reflected from a moving object, e.g., person 120, 220, in the external environment, RF sensors 108B may extract features from received Doppler radar signals. Such features can include a dominant Doppler signal feature, e.g., 310, 360, 410, an amplitude of which, e.g., D1, D4, may be utilized to indicate the physical size of a person (120, 220) approaching vehicle 102. Doppler signal features can additionally include Doppler side frequency features, e.g., 315, 320, 365, 370, 415, 420, to determine whether the moving object includes an authorized user, e.g., operator or passenger, of vehicle 102. In response to determining that the moving object does not include an authorized user, user identification programming 104A can actuate camera sensor 108A to record still or video images for transmission to server 140 via communications component 114 and network 130. In response to determining that the moving object includes an authorized user, programming of computer 104 can maintain camera sensors 108A in a deactivated state and can actuate a component to unlock one or more doors of vehicle 102, actuate interior lighting of vehicle 102, etc. In an example, RF sensors 108B may operate in a Doppler radar mode, or in a Bluetooth-based phone-as-a-key operational mode and may intermittently transition between the Doppler radar mode and the Bluetooth operational modes.

Prior to initiating process 500, programming of computer 104 and/or server 140 can execute a machine learning program as a separate process to detect an authorized user (e.g., an operator or passenger) of vehicle 102. In an example, RF sensor 108B can capture reflected radar signals from a prospective user, e.g., operator or passenger of vehicle 102. RF sensor 108B can then form dominant Doppler signal features (310, 360, 410) and Doppler side frequency features (315, 320, etc.) as the prospective user, e.g., operator or passenger, approaches vehicle 102. The machine learning programming of user identification programming 104A can further train and refine a computer model over instances of successful recognition (e.g., true positives), incorrect recognition (e.g., false positives), and related recognition events of an authorized user.

Process 500 can begin at block 510, which includes transmitting, such as via RF sensor 108B, a Doppler radar signal to an area external to vehicle 102. Transmission of Doppler radar signals can be performed while vehicle 102 is deactivated, parked, and unattended as a security measure to monitor areas external to vehicle 102.

Process 500 can continue at block 515, which includes processing received signals from a moving object, such as person 120, 220. Block 515 can additionally include processing received signals to determine dominant Doppler signal features (310, 360, 410), as well as Doppler side frequency features (315, 320, 365, 370, 415, 420).

Process 500 can continue at block 520, in which Doppler signal features, such as dominant Doppler signal features (310, 360, 410) and Doppler side frequency features (315, 320, 365, 370, 415, 420) are transmitted to user identification programming 104A. Programming 104A can determine a correlation between the Doppler signal features and the signal features of authorized users, e.g., operators or passengers, of vehicle 102 utilizing a table or other data structure stored in a memory accessible to programming 104A.

Process 500 can continue at block 525, at which programming 104A can utilize a time-series of recognitions of a person (120, 220), to determine a trajectory or other type of path over a time series of signal profiles (305, 355, 405). A time series of recognitions of a person (120, 220) may extend over any suitable duration, such as five seconds, 10 seconds, 15 seconds, etc.

Process 500 can continue at block 530, at which programming 104A can determine whether a person (120, 220) is advancing towards or retreating from vehicle 102 utilizing the trajectory determined at block 525. In an example, such as described in reference to FIG. 3, in response to Doppler side frequency features (315, 320, 365, 370, 415, 420) including a frequency greater than a dominant Doppler signal feature (310, 360, 410), the person (120, 220) may be determined to be advancing toward vehicle 102. In another example, such as in reference to FIG. 4, in response to Doppler side frequency features including a frequency less than a dominant Doppler signal feature, the person may be determined to be retreating (moving away) from vehicle 102. In response to the decision of block 530, process 500 may proceed to block 545 in which, as discussed below, programming of computer 104 may transition RF sensor 108B to perform phone-as-a-key functions.

In response to the decision of block 530 determining that the moving object is moving toward vehicle 102, the process 500 can continue at block 535, at which user identification programming 104A can assign a threat index to a moving object. In an example, a threat index may be based on a variety of factors, such as the speed of an approaching person, e.g., as determined by a frequency shift of a dominant Doppler signal feature (310, 360), a distance between the approaching person and vehicle 102, as determined by an amplitude of a dominant Doppler signal feature (310, 360), and/or a number of distinct dominant Doppler signal features (310, 360, 410) and Doppler side frequency features (315, 320, 365, 370).

Process 500 can continue at block 540, at which programming of computer 104 may actuate camera sensor 108A, which can result in the camera sensor capturing still or video images of person 120 for transmission via communications component 114 through network 130 to server 140.

Process 500 can continue at block 545, at which programming of computer 104 can transition RF sensor 108B from a Doppler radar mode to a Bluetooth phone-as-a-key mode, which allows a person, e.g., person 120, to unlock doors, illuminate interior lighting, etc., utilizing mobile communications device 122.

Process 500 can continue at block 550, at which RF sensor 108B can perform Bluetooth phone-as-a-key functions. Such functions may include receiving a signal from a Bluetooth low energy beacon from mobile communications device 122 of person 120.

Process 500 can continue at block 555, at which programming of computer 104 can transition RF sensor 108B to perform Doppler radar functions. In response to the transition of block 555, process 500 can return to block 510.

After block 555, process 500 ends.

The descriptions of the various examples and implementations have been presented for purposes of illustration but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media, e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
a computer including a processor coupled to a memory, the memory storing instructions executable by the processor to:
process a received Doppler radar signal to extract a feature that represents a characteristic of a moving object; and
responsive to determining that the moving object excludes an authorized user based on the extracted feature, actuate a camera sensor.

2. The system of claim 1, wherein the characteristic is at least one of a gait, a heel strike, an arm swing, a head nod, a twist, or a turn of the authorized user.

3. The system of claim 1, wherein the Doppler radar signal includes a dominant signal reflected from the moving object, and wherein the extracted feature indicates a characteristic gait based on the dominant signal.

4. The system of claim 1, wherein the instructions further include instructions to:
compute a composite feature of the moving object based on a relationship between two or more extracted features of the Doppler radar signal.

5. The system of claim 1, wherein the instructions further include instructions to:
determine a trajectory of the moving object based on a dominant feature of the Doppler radar signal.

6. The system of claim 1, wherein the instructions further include instructions to:
determine a trajectory of the moving object; and
assign a threat index to the moving object based on the trajectory.

7. The system of claim 6, wherein the instructions further include instructions to:
increase the threat index based on the trajectory indicating movement of the moving object toward the system.

8. The system of claim 1, wherein the camera sensor includes a vehicle-mounted camera sensor having a field-of-view that includes the location of the moving object.

9. The system of claim 1, wherein the camera sensor includes a vehicle-mounted camera sensor having a field-of-view that includes the moving object, and wherein actuation of the camera sensor includes capturing video images of the moving object.

10. The system of claim 1, wherein the instructions further include instructions to:
maintain the camera sensor in a deactivated state responsive to the moving object being determined to include the authorized user.

11. The system of claim 1, wherein the instructions further include instructions to:
transition the system from a Doppler radar operational mode to a Bluetooth operational mode after executing the instructions to actuate the camera sensor.

12. The system of claim 1, wherein the instructions further include instructions to:
refine a computer model that includes the characteristic of the moving object based on successful recognitions that the moving object includes the authorized user.

13. A method comprising:
processing a received Doppler radar signal to extract a feature that represents a characteristic of a moving object;
determining that the moving object excludes an authorized user based on the extracted feature; and
actuating a camera sensor.

14. The method of claim 13, wherein the characteristic is at least one of a gait, a heel strike, an arm swing, a head nod, a twist, or a turn of the authorized user.

15. The method of claim 13, further comprising:
determining a trajectory of the moving object based on a dominant feature of the Doppler radar signal reflected from the moving object.

16. The method of claim 13, further comprising:
determining a trajectory of the moving object; and
assigning a threat index to the moving object based on the trajectory.

17. The method of claim 16, further comprising:
assigning an increased threat index based on the trajectory indicating movement of the moving object toward the camera sensor.

18. The method of claim 13, further comprising:
maintaining the camera sensor in a deactivated state responsive to determining that the moving object includes the authorized user.

19. The method of claim 13, further comprising:
transitioning the Doppler radar to a Bluetooth operational mode after actuating the camera sensor.

20. The method of claim 13, further comprising:
refining a computer model that includes the characteristic of the authorized user based on successive recognitions that the moving object includes the authorized user.
